(19) United States
(12) Patent Application Publication
(10) Pub. No.: US 2017/0015262 A1
(43) Pub. Date: Jan. 19, 2017

(54) BACKUP BATTERY SYSTEM

(71) Applicant: YAZAKI CORPORATION, Tokyo (JP)

(72) Inventor: Hideaki Kikuchi, Shizuoka (JP)

(21) Appl. No.: 15/202,326

(22) Filed: Jul. 5, 2016

(30) Foreign Application Priority Data
Jul. 16, 2015 (JP) 2015-141995

(51) Int. Cl. B60R 16/033

(52) U.S. Cl. CPC B60R 16/033

(57) ABSTRACT

Provided is a backup battery system including a plurality of power supply control boxes which are disposed one by one in sections of a vehicle, each power supply control box distributes and supplies electric power received from a vehicle battery to electric power required devices, which include backup required devices and are provided in the section in which the power supply control box is disposed together; and a power supply wire that connects the plurality of power supply control boxes to each other. One of the plurality of power supply control boxes is connected to the vehicle battery, and another power supply control box is connected to a backup battery that becomes an electric power supply source when electric power supply from the vehicle battery is impossible.

### CROSS-REFERENCE TO RELATED APPLICATION(S)

The present application claims priority to and incorporates by reference the entire contents of Japanese Patent Application No. 2015-141995 filed in Japan on Jul. 16, 2015.

### BACKGROUND OF THE INVENTION

1. Field of the Invention

The present invention relates to a backup battery system.

2. Description of the Related Art

In devices which receive power supply from a vehicle battery, a serious problem may occur when the power supply is shut off and thus the device does not operate. A backup battery, which is different from the vehicle battery, is connected to the devices for normal operation even when the power supply from the vehicle battery is shut off (for example, refer to Japanese Patent Application Laid-open No. 2014-180941).

The inventors of the present application have made an examination with respect to a configuration in which a backup battery is connected to an important device similar to the invention described in Japanese Patent Application Laid-open No. 2014-180941, and have made an examination with respect to a configuration of allowing the device to operate even when power supply from a vehicle battery is shut off. Hereinafter, such device is referred to as a backup required device.

However, recently, along with higher performance in regard to an in-vehicle device, there is a tendency in which the number of backup required devices in a vehicle increases. Therefore, it is necessary to connect a backup battery to each of the backup required devices, and thus it is necessary to mount a lot of backup batteries in a vehicle.

With regard to the necessity, a configuration, in which one backup battery is provided in a vehicle, and the one backup battery and each of the plurality of backup required devices are connected, may be considered. However, in this case, for example, the connection is made by routing an electric wire from the one backup battery to each of the backup required devices present over a range from a front side to a rear side of the vehicle. Accordingly, along with an increase in the electric wire for backup electric power transmission which is used in the vehicle, a total distance (hereinafter, simply referred to as “electric wire length”) of the electric wire that is used in the vehicle increases.

### SUMMARY OF THE INVENTION

The present invention has been made to solve the above-described problem, and an object thereof is to provide a backup battery system that is capable of suppressing an electric wire length while suppressing the number of backup batteries which are mounted in a vehicle.

A backup battery system according to one aspect of the present invention includes a plurality of power supply control boxes which are disposed one by one in sections obtained by dividing a vehicle into a plurality of sections, each power supply control box being configured to distribute and supply electric power that is received from a vehicle battery to one or more electric power required devices, which include one or a plurality of backup required devices and are provided in the section in which the power supply control box is disposed, among a plurality of electric power required devices which require electric power supply; and a power supply wire that connects the plurality of power supply control boxes to each other, and is capable of performing electric power transmission therebetween, wherein one of the plurality of power supply control boxes is connected to the vehicle battery, and another power supply control box is connected to a backup battery that becomes an electric power supply source at a time electric power supply from the vehicle battery is impossible, among the plurality of power supply control boxes, one power supply control box, which is connected to the backup battery, includes a power reception unit configured to receive operation electric power at the time electric power supply from the vehicle battery is impossible, and a switching control unit configured to receive the operation electric power by the power reception unit, and perform switching to a state of receiving electric power from the backup battery in a case where a signal, which indicates that electric power supply from the vehicle battery is impossible, is input, and electric power from the backup battery is supplied to the power supply wire through the switching by the switching control unit.

According to the backup battery system according to the present invention, the plurality of power supply control boxes are connected by the power supply wire, and the vehicle battery is connected to one of the power supply control boxes, and the backup battery is connected to a different one of the power supply control boxes. Accordingly, in a case where electric power supply from the vehicle battery is retained, electric power form the vehicle battery is supplied to one power supply control box, and is supplied from the power supply control box to electric power required devices in the same section. In addition, electric power from the vehicle battery reaches the power supply wire through the one power supply control box and is supplied to a different one of the power supply control boxes. In addition, electric power is supplied from the different power supply control box to electric power required devices in the same section.

In contrast, in a case where electric power supply from the vehicle battery is impossible, electric power from the backup battery is supplied to the different one of the power supply control boxes, and is supplied from the power supply control box to backup required devices in the same section. In addition, electric power from the backup battery reaches the power supply wire through the different one of the power supply control boxes, and is supplied to other power supply control boxes. In addition, electric power is supplied from the other power supply control box to backup required devices in the same section.

As described above, when electric power supply from the vehicle battery is impossible, electric power from one backup battery can be supplied to backup required devices, and backup electric power can be supplied by using an electric power supply route from the vehicle battery. Accordingly, it is possible to reduce the number of electric wires dedicated to backup electric power, and it is possible to suppress an electric wire length. As a result, it is possible to suppress the electric wire length while suppressing the number of backup batteries.

Furthermore, among the plurality of power supply control boxes, one power supply control box, which is connected to the backup battery, includes a power reception unit that receives operation electric power when electric power supply from the vehicle battery is impossible. Accordingly, even when electric power supply from the vehicle battery is impossible, for example, a temporary operation is possible. In addition, in the power supply control box that is connected to the backup battery, in a case where a signal, which indicates that electric power supply from the vehicle battery is impossible, is input, the operation electric power is received by the power reception unit to perform the temporary operation, and switching to a state of receiving electric power from the backup battery is performed. According to this, even when electric power supply from the vehicle battery is impossible, electric power from the backup battery can be transmitted to the power supply wire, which becomes an electric power supply route, through the switching.

According to another aspect of the present invention, in the backup battery system, it is preferable that the backup battery is disposed in the section that includes a position opposite to a position at which the vehicle battery is disposed.

According to the backup battery system, the backup battery is disposed in a section that includes a position opposite to a position at which the vehicle battery is disposed. Accordingly, even in a situation such as breakage of the vehicle battery due to vehicle accident and the like, since the backup battery is disposed in a section that is opposite to the vehicle battery and is spaced away from the vehicle battery, it is possible to reduce a possibility of breakage, and when electric power supply from the vehicle battery is impossible, it is possible to allow the backup battery to function.

According to still another aspect of the present invention, in the backup battery system, it is preferable that the backup battery is disposed in the section on a center side excluding sections on a front end side and on a rear end side of the vehicle.

According to the backup battery system, the backup battery is disposed in a section on a center side excluding sections on a front end side and on a rear end side of the vehicle. Accordingly, for example, even in a case where the vehicle battery is mounted on a front side or a rear side of the vehicle, and the vehicle battery may be broken due to collision on the front side of the vehicle or collision on the rear side of the vehicle, since the backup battery is provided in a section on the center side, the backup battery is less likely to be broken due to collision on the front side of the vehicle or collision on the rear side of the vehicle, and can be allowed to function when electric power supply from the vehicle battery is impossible.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a backup battery system according to an embodiment of the present invention;

FIG. 2 is a block diagram illustrating a configuration of a third power supply control box that is illustrated in FIG. 1;

FIG. 3 is a block diagram illustrating a configuration of a second power supply control box that is illustrated in FIG. 1;

FIG. 4 is a block diagram illustrating a configuration of a first power supply control box that is illustrated in FIG. 1; and

FIG. 5 is a schematic configuration diagram of a backup battery system according to a second embodiment.

### DETAILED DESCRIPTION OF THE PREFERRED EMBODIMENTS

Hereinafter, the invention will be described with reference to preferred embodiments. Furthermore, the invention is not limited to the following embodiments, and appropriate modifications can be made in a range not departing from the gist of the invention. In addition, in the following embodiments, illustration or description of partial configurations is omitted, but it is needless to say that a technology, which is well known or commonly known, is appropriately applied to details of a technology that is omitted in a range in which a discrepancy from the following contents does not occur.

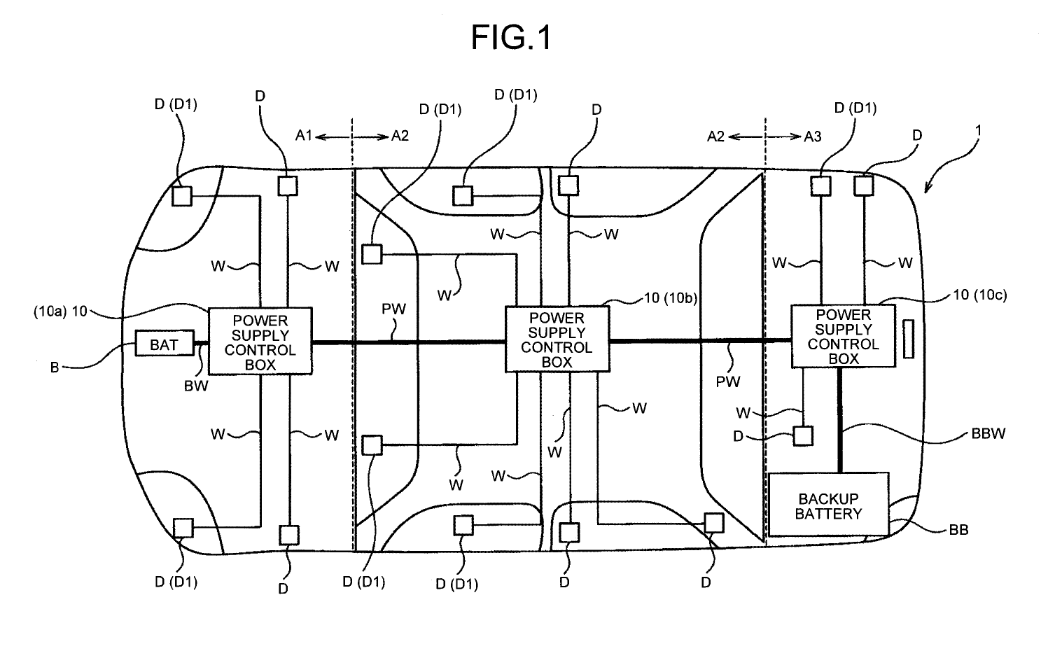

FIG. 1 is a schematic configuration diagram of a backup battery system 1 according to an embodiment of the present invention. As illustrated in FIG. 1, the backup battery system 1 according to this embodiment supplies electric power from a vehicle battery B to a plurality of electric power required devices D which require electric power supply during a normal operation, and supplies electric power from a backup battery BB to a plurality of backup required devices (the entirety or a part of the electric power required devices D) D1 when electric power supply from the vehicle battery B is impossible.

Examples of the backup required devices D1 include an air-bag activation unit, a steering-by-wire unit that is a system in which a steering wheel and an actuator are connected with an electric wire through a computer, and the actuator controls a tire turning angle, an electric motor brake, a shift-by-wire unit that is a system in which a shift and a transmission are connected with an electric wire through a computer, and an actuator in the transmission controls a gear, and the like.

Here, examples of a case where electric power supply is impossible as described above include a case where a predetermined voltage is not obtained due to deterioration or failure of the vehicle battery B, disconnection of an electric wire (a battery wire BW or a power supply wire PW to be described later) that connects the vehicle battery B and a power supply control box 10, and the like. In the following description, description will be made on the assumption of a case where a predetermined voltage is not obtained due to failure of the vehicle battery B.

Furthermore, the kind of the electric power required devices D is various, but the same reference numeral D will be given regardless of the kind. In addition, the same numeral D will be given in both a case of indicating the entirety of the electric power required devices D and a case of indicating a part thereof. In addition, this is also true of the backup required devices D1.

The backup battery system 1 includes the vehicle battery B, the plurality of electric power required devices D (in this embodiment, parts of the electric power required devices D are the backup required devices D1), a plurality of the power supply control boxes 10, a power supply wire PW, respective electric wires W, BW, and BBW, and a backup battery BB.

The plurality of power supply control boxes 10 are disposed one by one in sections A1 to A3 which are obtained by dividing a vehicle into a plurality of (three) rectangular sections A1 to A3 when viewed from an upper side, and distribute and supply electric power that is received to the electric power required devices D, which are provided in the section in which the power supply control box 10 is disposed therewith, among the plurality of electric power required devices D. For example, the power supply wire PW is a thick electric wire that connects the plurality of power supply control boxes 10 to each other and is capable of performing electric power transmission therebewteen.

In the backup battery system 1 according to this embodiment, one of the plurality of power supply control boxes 10 is connected to the vehicle battery B, and a different one except for the one power supply control box 10 is connected to the backup batter BB.

Specifically, a first power supply control box 10a is disposed in a front section A1, a second power supply control box 10b is disposed in a central section A2, and a third power supply control box 10c is disposed in a rear section A3. Here, the vehicle battery B is mounted in the front section A1, and the vehicle battery B and the first power supply control box 10a are connected to each other with the battery wire BW. In addition, the power supply wire PW is also provided between the first power supply control box 10a and the second power supply control box 10b, and between the second power supply control box 10b and the third power supply control box 10c for connection therebetween. According to this, electric power from the vehicle battery B is supplied to the first power supply control box 10a through the battery wire BW, and is supplied from the first power supply control box 10a to the second and third power supply control boxes 10b and 10c through the power supply wire PW.

In the following description, a reference numeral 10 will be given to the entirety of the plurality of power supply control boxes 10, or the reference numeral 10 will be given in a case of not specifying any one of the plurality of power supply control boxes 10. In addition, reference numerals 10a to 10c will be given in a case of specifying any one of the plurality of power supply control boxes 10.

Each of power supply control boxes 10a to 10c is connected to all of electric power required devices D, which are disposed in the same section among the sections A1 to A3, through an individual electric wire W. Accordingly, each of the power supply control boxes 10a to 10c distributes and supplies electric power to all of the electric power required devices D which are disposed in the same section among the sections A1 to A3. Specifically, in an example illustrated in FIG. 1, four electric power required devices D are provided in the front section A1, and the first power supply control box 10a distributes and supplies electric power to the four electric power required devices D. In addition, seven electric power required devices D are provided in the central section A2, and the second power supply control box 10b distributes and supplies electric power to the seven electric power required devices D. In addition, three electric power required devices D are provided in the rear section A3, and the third power supply control box 10c distributes and supplies electric power to the three electric power required devices D. In addition, the electric power required devices D in each of the sections A1 to A3 is not limited to a plurality of devices, and may be provided one by one.

In addition, the backup battery BB is mounted in the rear section A3, and the backup battery BB and the third power supply control box 10c are connected to each other through a backup battery wire BBW. In this manner, the backup battery BB is disposed in the section A3 that includes a position that is opposite to a position at which the vehicle battery B is disposed. The opposite position is a position which is point symmetric with respect to the center of a vehicle in a case where the vehicle is viewed from an upper side. Accordingly, for example, in a case where the vehicle is viewed from an upper side, when it is assumed that the vehicle battery B is located at a site that is spaced away from a front end of the vehicle by X cm and is spaced away from a right end of the vehicle by Y cm, the section including the opposite position represents a section including a position that is spaced away from a rear end of the vehicle by X cm and is spaced away from a left end of the vehicle by Y cm. In this manner, in a case where the backup battery BB is disposed at the opposite position, even in a situation such as breakage of the vehicle battery B due to vehicle accident and the like, it is possible to reduce possibility that the backup battery BB is broken.

In addition, during failure of the vehicle battery B, electric power is supplied from the backup battery BB to the third power supply control box 10c through the backup battery wire BBW. In addition, electric power is supplied from the third power supply control box 10c to the first and second power supply control boxes 10a and 10b through the power supply wire PW. Each of the power supply control boxes 10a to 10c distributes and supplies electric power to all of the backup required devices D1 which are disposed in the same section among the sections A1 to A3. Specifically, in the example illustrated in FIG. 1, one backup required device D1 is provided in the rear section A3, the third power supply control box 10c supplies electric power to the one backup required device D1. In addition, four backup required devices D1 are provided in the central section A2, and the second power supply control box 10b distributes and supplies electric power to the four backup required devices D1. In addition, two backup required devices D1 are provided in the front section A1, and the first power supply control box 10a distributes and supplies electric power to the two backup required devices D1.

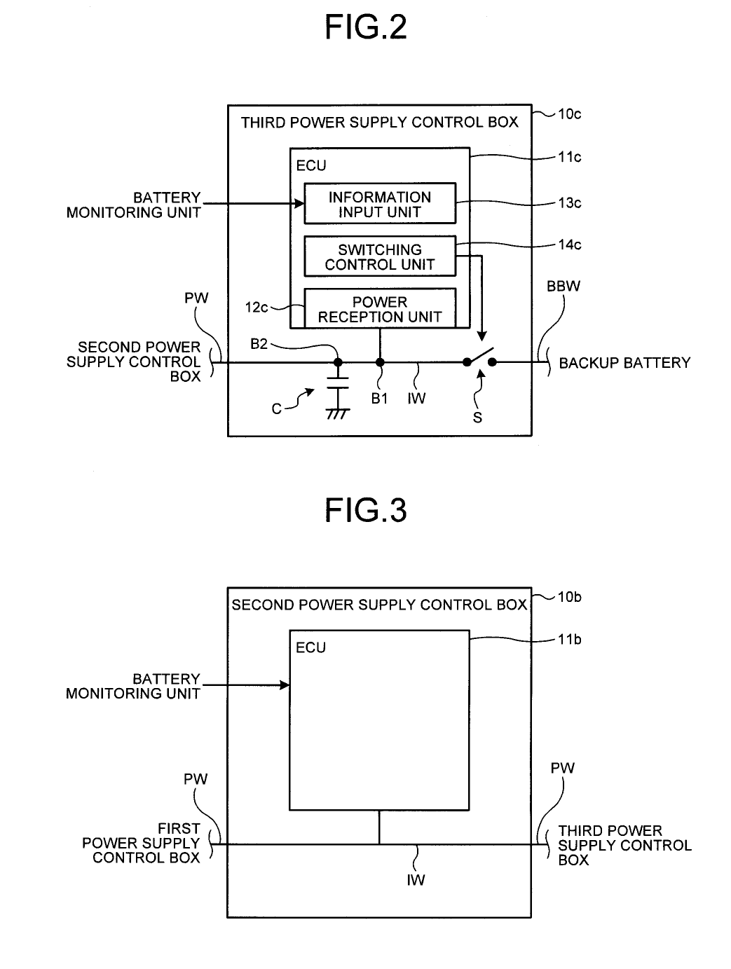

FIG. 2 is a block diagram illustrating a configuration of the third power supply control box 10c illustrated in FIG. 1. As illustrated in FIG. 2, the third power supply control box 10c includes an ECU 11c at the inside thereof. The ECU 11c executes switch control during supply of electric power to each of the electric power required devices D or the backup required device D1. When a signal described later, which indicates that electric power supply from the vehicle battery B is impossible, is input, the ECU 11c switches from a state in which electric power is supplied to the electric power required device D to a state in which electric power is supplied to the backup required device D1. In addition, the ECU 11c includes a power reception unit 12c, an information input unit 13c, and a switching control unit 14c as a function unit. In addition, the third power supply control box 10c includes an internal electric wire IW, a large-capacity capacitor C that becomes an emergent power supply during emergency, and a switch S.

The internal electric wire IW is an electric wire that connects the power supply wire PW and the backup battery wire BBW. The internal electric wire IW is branched on a branch point B1 and a branch wire is connected to the ECU 11c. One end of the capacitor C is connected to a connection point B2 of the internal electric wire IW, and the other end is connected to a ground. Accordingly, during a normal operation, the capacitor C enters a state of being charged with electric power that is supplied through the power supply wire PW. The switch S is disposed on a backup battery BB side (on a more backup battery BB side in comparison to the branch point B1 and the connection point B2) on the internal electric wire IW, and is turned on or turned off so as to electrically connect or disconnect the ECU 11c and the backup battery BB. During a normal operation, the switch S is in an opened state, and the ECU 11c and the backup battery BB are disconnected.

The power reception unit 12c is a function unit that receives electric power from the vehicle battery B, and functions to receive operation electric power for a temporary operation when electric power supply from the vehicle battery B is impossible. When electric power supply is impossible, electric power is not supplied through the power supply wire PW. In this case, the capacitor C enters a discharging state, and the power reception unit 12c receives electric power from the capacitor C. According to this, the ECU 11c can temporarily operate.

On the other hand, the information input unit 13c of the ECU 11c inputs information from an outer side. Here, in a vehicle, whether or not the vehicle battery B is in an abnormal state is monitored from necessity such as notifying a driver and the like of the abnormality in the vehicle battery B. The information input unit 13c inputs a signal from a battery monitoring unit. In addition, in a situation in which electric power supply from the vehicle battery B is impossible, the information input unit 13c inputs a signal indicating the situation.

In a case where the information input unit 13c inputs the signal indicating that electric power supply from the vehicle battery B is impossible, the switching control unit 14c performs switching to a state of receiving electric power from the backup battery BB. In this case, the switching control unit 14c according to the example illustrated in FIG. 2 can temporarily operate by receiving operation electric power with the power reception unit 12c, and turns on the switch S so as to introduce electric power from the backup battery BB.

As described above, electric power from the backup battery BB is supplied to the third power supply control box 10c, and electric power from the backup battery BB is also supplied to the first and the second power supply control boxes 10a and 10b through the power supply wire PW. According to this, the power supply control boxes 10a to 10c supply electric power to the backup required devices D1.

Note that a route, through which electric power is supplied to the electric power required devices D or the backup required devices D1, and components such as a switching element on the route are not illustrated in FIG. 2. In addition, operation electric power of ECU 11c is, for example, 5 V or the like, and thus a unit that lowers a voltage from the vehicle battery B or a voltage from the backup battery BB is also not illustrated in FIG. 2.

FIG. 3 is a block diagram illustrating a configuration of the second power supply control box 10b illustrated in FIG. 1. As illustrated in FIG. 3, the second power supply control box 10b includes an ECU 11b at the inside thereof. The ECU 11b performs switching control when supplying electric power to the electric power required devices D or the backup required devices D1. When a signal, which indicates that electric power supply from the vehicle battery B is impossible, is input, the ECU 11b is switched from a state in which electric power is supplied to the electric power required devices D into a state in which electric power is supplied to the backup required devices D1. In addition, the second power supply control box 10b includes an internal electric wire IW.

As described above, the second power supply control box 10b has a configuration in which the large-capacity capacitor C that becomes an emergent power supply during emergency, the switch S, the power reception unit 12c, and the like are not provided. In addition, as is the case with FIG. 2, a route, through which electric power is supplied to the electric power required devices D or the backup required devices D1, and components such as a switching element on the route are not illustrated in FIG. 3. In addition, operation electric power of the ECU 11b is, for example, 5 V or the like, and thus a unit that lowers a voltage from the vehicle battery B or a voltage from the backup battery BB is also not illustrated in FIG. 3.

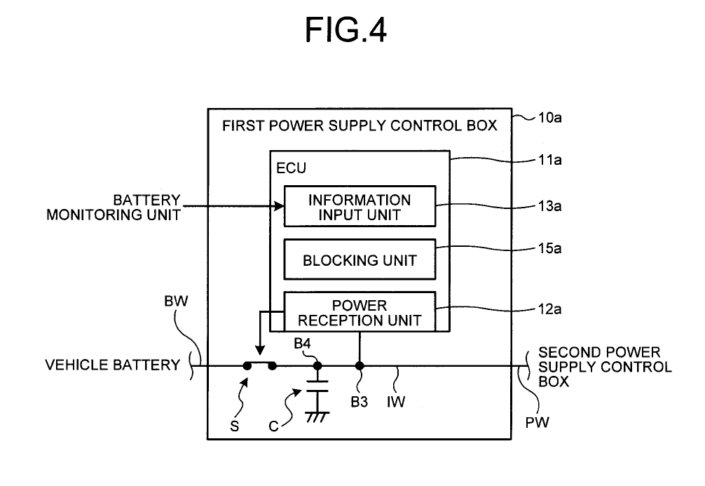

FIG. 4 is a block diagram illustrating a configuration of the first power supply control box 10a illustrated in FIG. 1. As illustrated in FIG. 4, the first power supply control box 10a includes an ECU 11a at the inside thereof. The ECU 11a performs switching control when supplying electric power to the electric power required devices D or the backup required devices D1. When a signal, which indicates that electric power supply from the vehicle battery B is impossible, is input, the ECU 11a is switched from a state in which electric power is supplied to the electric power required devices D into a state in which electric power is supplied to the backup required devices D1. In addition, the ECU 11a includes a power reception unit 12a, an information input unit 13a, and a blocking unit 15a as a function unit. In addition, the first power supply control box 10a includes an internal electric wire IW, a large-capacity capacitor C that becomes an emergent power supply during emergency, and a switch S.

The internal electric wire IW is an electric wire that connects a battery wire BW and the power supply wire PW. The internal electric wire IW is branched on a branch point B3 and a branch wire is connected to the ECU 11a. One end of the capacitor C is connected to a connection point B4 of the internal electric wire IW, and the other end is connected to a ground. Accordingly, during a normal operation, the capacitor C enters a state of being charged with electric power that is supplied through the power supply wire PW. The switch S is disposed on a vehicle battery B side (on a more vehicle battery B side in comparison to the branch point B3 and the connection point B4) on the internal electric wire IW, and is turned on or turned off so as to electrically connect or disconnect the ECU 11a and the vehicle battery B. During a normal operation, the switch S is in a closed state, and the ECU 11a and the vehicle battery B are electrically connected.

The power reception unit 12a is a function unit that receives electric power from the vehicle battery B, and functions to receive operation electric power for a temporary operation when electric power supply from the vehicle battery B is impossible. When electric power supply is impossible, if electric power is not supplied through the power supply wire PW, the capacitor C enters a discharging state, and the power reception unit 12a receives electric power from the capacitor C. According to this, the ECU 11a can temporarily operate.

On the other hand, the information input unit 13a of the ECU 11a inputs a signal from the battery monitoring unit. In a situation in which electric power supply from the vehicle battery B is impossible, the information input unit 13a inputs a signal, which indicates the situation, from the battery monitoring unit.

In a case where the information input unit 13a inputs the signal indicating that electric power supply from the vehicle battery B is impossible, the blocking unit 15a blocks electrical connection between the first power supply control box 10a and the vehicle battery B. That is, in an example illustrated in FIG. 4, the blocking unit 15a can temporarily operate by receiving operation electric power with the power reception unit 12a, and turns off the switch S so as to block electric power supply from the vehicle battery B.

Here, during failure of the vehicle battery B, there is a possibility that the vehicle battery B may be broken and thus electric power may not be supplied at all, and an abnormal current may be introduced to the first power supply control box 10a. In this case, the blocking unit 15a turns off the switch S and disconnects electrical connection with the vehicle battery B so as to prevent failure of the ECU 11a and the like.

Note that a route, through which electric power is supplied to the electric power required devices D or the backup required devices D1, and components such as a switching element on the route are not illustrated in FIG. 4. In addition, operation electric power of ECU 11a is, for example, 5 V or the like, and thus a unit that lowers a voltage from the vehicle battery B or a voltage from the backup battery BB is also not illustrated in FIG. 4.

Next, description will be given of an operation of the backup battery system 1 according to this embodiment. First, the switch S of the first power supply control box 10a is on, and the switch S of the third power supply control box 10c is off.

In this case, electric power from the vehicle battery B reaches the first power supply control box 10a through the battery wire BW, and reaches the second and third power supply control boxes 10b and 10c through the power supply wire PW. Each of the power supply control boxes 10 distributes and supplies electric power to every electric power required device D which is disposed in the same section therewith among the sections A1 to A3.

Here, it is assumed that failure of the vehicle battery B occurs. At this time, determination of the failure is made by the battery monitoring unit of the vehicle battery B, and a signal, which indicates that electric power supply from the vehicle battery B is impossible, is output. According to this, the information input unit 13c of the third power supply control box 10c inputs the signal indicating that electric power supply from the vehicle battery B is impossible. In addition, the switching control unit 14c of the third power supply control box 10c turns on the switch S so as enter a state in which electric power form the backup battery BB is received. Operation electric power when turning on the switch S is supplied from the capacitor C in the third power supply control box 10c.

Similarly, the information input unit 13a of the first power supply control box 10a inputs the signal indicating that electric power supply from the vehicle battery B is impossible. In addition, the blocking unit 15a of the first power supply control box 10a turns off the switch S to disconnect electrical connection with the vehicle battery B. Operation electric power when turning off the switch S is also supplied from the capacitor C in the first power supply control box 10a.

As described above, according to the backup battery system 1 according to the first embodiment, the power supply wire PW connects the plurality of power supply control boxes 10 to each other, the vehicle battery B is connected to one (the first power supply control box 10a) of the power supply control boxes 10, and the backup battery BB is connected to a different one (the third power supply control box 10c). Accordingly, in a case where electric power supply from the vehicle battery B is retained, electric power from the vehicle battery B is supplied to the first power supply control box 10a, and is supplied from the first power supply control box 10a to the electric power required device D in the same section A1. In addition, electric power from the vehicle battery B reaches the power supply wire PW through the first power supply control box 10a, and is supplied to the second and third power supply control boxes 10b and 10c. In addition, electric power is supplied from each of the second and third power supply control boxes 10b and 10c to the electric power required devices D in the same section between the sections A2 and A3.

In contrast, in a case where electric power supply from the vehicle battery B is impossible, electric power from the backup battery BB is supplied to the third power supply control box 10c, and is supplied from the third power supply control box 10c to the backup required devices D1 in the same section A3. In addition, electric power from the backup battery BB reaches the power supply wire PW through the third power supply control box 10c, and is supplied to the first and second power supply control boxes 10a and 10b. In addition, electric power is supplied from each of the first and second power supply control boxes 10a and 10b to the backup required devices D1 in the same section between the sections A1 and A2.

As described above, when electric power supply from the vehicle battery B is impossible, electric power from one backup battery BB can be supplied to the backup required devices D1, and backup electric power can be supplied by using an electric power supply route from the vehicle battery B. Accordingly, it is possible to reduce the number of electric wires dedicated to backup electric power, and it is possible to suppress an electric wire length. As a result, it is possible to suppress the electric wire length while suppressing the number of backup batteries BB.

Furthermore, among the plurality of power supply control boxes 10, the third power supply control box 10c, which is connected to the backup battery BB, includes the power reception unit 12c that receives operation electric power when electric power supply from the vehicle battery B is impossible. Accordingly, even when electric power supply from the vehicle battery B is impossible, for example, a temporary operation is possible. In addition, in the power supply control box 10 which is connected to the backup battery BB, in a case where a signal, which indicates that electric power supply from the vehicle battery B is impossible, is input, the operation electric power is received by the power reception unit 12c to perform the temporary operation, and switching to a state of receiving electric power from the backup battery BB is performed. According to this, even when electric power supply from the vehicle battery B is impossible, electric power from the backup battery BB can be transmitted to the power supply wire PW, which becomes an electric power supply route, through the switching.

In addition, the backup battery BB is disposed in a section A3 that includes a position opposite to a position at which the vehicle battery B is disposed. Accordingly, even in a situation such as breakage of the vehicle battery B due to vehicle accident and the like, since the backup battery BB is disposed in a section A3 that is opposite to the vehicle battery B and is spaced away from the vehicle battery B, it is possible to reduce a possibility of breakage, and when electric power supply from the vehicle battery B is impossible, it is possible to allow the backup battery BB to function.

Next, description will be given of a second embodiment according to the present invention. A backup battery system according to the second embodiment is substantially the same as the backup battery system in the first embodiment except for a partial configuration. Hereinafter, description will be given of a difference from the first embodiment.

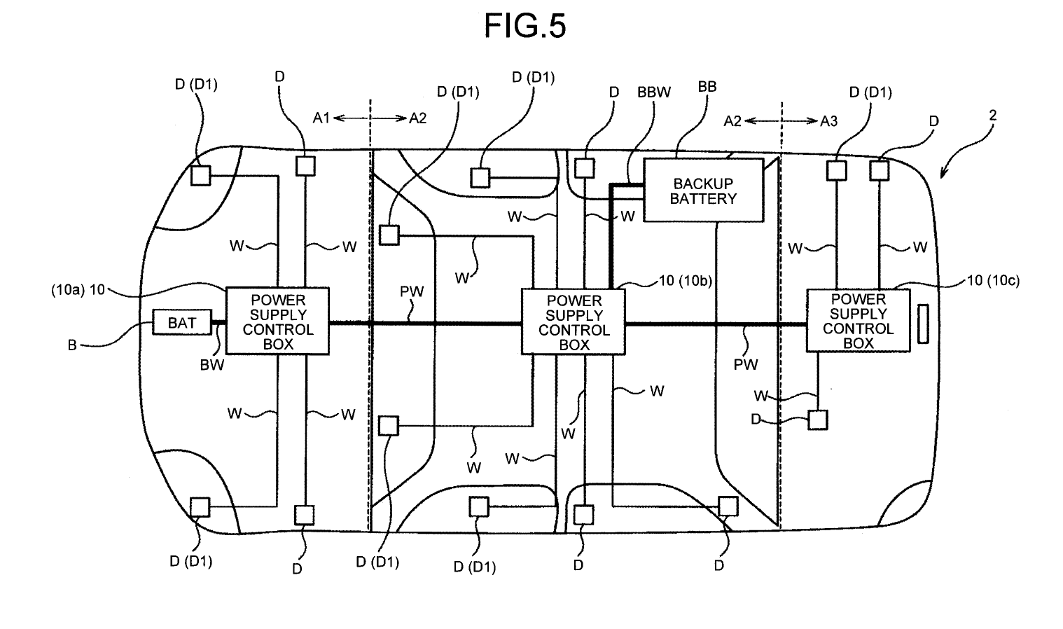

FIG. 5 is a schematic configuration diagram of a backup battery system 2 according to the second embodiment. The backup battery system 2 illustrated in FIG. 5 is different from the backup battery system of the first embodiment in a mounting position of the backup battery BB. That is, the backup battery BB is disposed in a section on a center side except for sections on a front end side and a rear end side of a vehicle. In this embodiment, three sections including a front section A1, a central section A2, and a rear section A3 are provided, and thus the backup battery BB is disposed in the central section A2.

In addition, in the second embodiment, the backup battery BB, which is disposed in the central section A2, is connected to the second power supply control box 10b with the backup battery wire BBW. The other configurations are the same as in the first embodiment.

Furthermore, a detailed configuration of a power supply control box 10 according to the second embodiment is also the same as in the first embodiment. Particularly, an internal configuration of a second power supply control box 10b according to the second embodiment is similar to that of the third power supply control box 10c described in the first embodiment, and an internal configuration of a third power supply control box 10c according to the second embodiment is similar to that of the second power supply control box 10b described in the first embodiment.

As described above, according to the backup battery system 2 according to the second embodiment, it is possible to suppress an electric wire length while suppressing the number of backup batteries BB. In addition, even when electric power supply from the vehicle battery B is impossible, electric power from the backup battery BB can be transmitted to the power supply wire PW, which becomes an electric power supply route, through the switching.

In addition, the backup battery BB is disposed in the section A2 on the central side except for the sections A1 and A3 on the front end side and the rear end side of the vehicle. Accordingly, for example, even in a case where the vehicle battery B is mounted on a front side or a rear side of the vehicle, and the vehicle battery B may be broken due to collision on the front side of the vehicle or collision on the rear side of the vehicle, since the backup battery BB is provided in a section on the center side, the backup battery BB is less likely to be broken due to collision on the front side of the vehicle or collision on the rear side of the vehicle, and the backup battery BB can be allowed to function when electric power supply from the vehicle battery B is impossible.

Hereinbefore, the invention has been described on the basis of the embodiments. However, the invention is not limited to the embodiments, and a modification can be made in a range not departing from the gist of the invention, and other technologies may be appropriately combined in a permissible range.

For example, in the embodiments, the backup required devices D1 are not limited to the above-described examples, and may be other devices. In addition, the number of the power supply control boxes 10 is not particularly limited to three as long as a plurality of the power supply control boxes 10 are provided.

In addition, the ECU 11a, 11b and 11c may determine whether or not electric power supply from the vehicle battery B is impossible by using a signal input from a current sensor or a voltage sensor that is provided on the battery wire BW or the power supply wire PW without limitation to a case of determining whether or not electric power supply from the vehicle battery B is impossible on the basis of the signal from the battery monitoring unit of the vehicle battery B. In this case, an abnormal value signal from the current sensor or the voltage sensor corresponds to the signal indicating that electric power supply from the vehicle battery is impossible.

In addition, the power supply control boxes 10 illustrated in FIG. 2 secure temporary operation electric power by using electric power from the capacitor C when electric power supply from the vehicle battery B is impossible, but may operate by receiving electric power from an alternator (not illustrated) during regeneration without limitation to the capacitor C. In addition, a control unit and the like may be provided on a backup battery BB side, and the control unit and the like may periodically operate so as to allow the power supply control boxes 10 to temporarily operate.

In addition, in the embodiments, as a case where electric power supply is impossible, failure of the vehicle battery B and the like are assumed. However, there is no limitation thereto, and disconnection of the battery wire BW or the power supply wire PW may be assumed as the case where electric power supply is impossible. In addition, in a case where the power supply wire PW, which connects the first power supply control box 10a and the second power supply control box 10b to each other, is disconnected, electric power form the vehicle battery B may be distributed and supplied to the electric power required devices D by the first power supply control box 10a, and electric power from the backup battery BB may be supplied to the backup required devices D1 by the second and third power supply control boxes 10b and 10c.

In addition, in the embodiment, each of the power supply control boxes 10 is connected to all of the electric power required devices D in the same section among the sections A1 to A3, and supplies electric power from the vehicle battery B. However, there is no limitation thereto, and each of the power supply control boxes 10 may be connected to a part of the electric power required devices D in the same section among the sections A1 to A3. However, in this case, a part of the electric power required devices D includes all of the backup required devices D1 in the same section among the sections A1 to A3. That is, it is necessary for each of the power supply control boxes 10 to be connected to every backup required device D1 in the same section among the sections A1 to A3.

According to the present invention, it is possible to provide a backup battery system capable of suppressing an electric wire length while suppressing the number of backup batteries which are mounted in a vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A backup battery system, comprising:
a plurality of power supply control boxes which are disposed one by one in sections obtained by dividing a vehicle into a plurality of sections, each power supply control box being configured to distribute and supply electric power that is received from a vehicle battery to one or more electric power required devices, which include one or a plurality of backup required devices and are provided in the section in which the power supply control box is disposed, among a plurality of electric power required devices which require electric power supply; and
a power supply wire that connects the plurality of power supply control boxes to each other, and is capable of performing electric power transmission therebetween, wherein
one of the plurality of power supply control boxes is connected to the vehicle battery, and another power supply control box is connected to a backup battery that becomes an electric power supply source at a time electric power supply from the vehicle battery is impossible,
among the plurality of power supply control boxes, one power supply control box, which is connected to the backup battery, includes a power reception unit configured to receive operation electric power at the time electric power supply from the vehicle battery is impossible, and a switching control unit configured to receive the operation electric power by the power reception unit, and perform switching to a state of receiving electric power from the backup battery in a case where a signal, which indicates that electric power supply from the vehicle battery is impossible, is input, and
electric power from the backup battery is supplied to the power supply wire through the switching by the switching control unit.

2. The backup battery system according to claim 1, wherein
the backup battery is disposed in the section that includes a position opposite to a position at which the vehicle battery is disposed.

3. The backup battery system according to claim 1, wherein
the backup battery is disposed in the section on a center side excluding sections on a front end side and on a rear end side of the vehicle.
